(19) United States
(12) Patent Application Publication
(10) Pub. No.: US 2023/0004417 A1
(43) Pub. Date: Jan. 5, 2023

(54) METHOD AND APPARATUS TO SELECT ASSIGNABLE DEVICE INTERFACES FOR VIRTUAL DEVICE COMPOSITION

(71) Applicant: Intel Corporation, Santa Clara, CA (US)

(72) Inventors: Karthik V. NARAYANAN, Chandler, AZ (US); Raghunathan SRINIVASAN, Chandler, AZ (US); Karthik KUMAR, Chandler, AZ (US)

(21) Appl. No.: 17/903,327

(22) Filed: Sep. 6, 2022

(51) Int. Cl. G06F 9/455; G06F 9/54

(52) U.S. Cl. CPC G06F 9/45558; G06F 9/542; G06F 2009/45579

(57) ABSTRACT

Scalable I/O Virtualization (Scalable IOV) allows efficient and scalable sharing of Input/Output (I/O) devices across a large number of containers or Virtual Machines. Scalable IOV defines the granularity of sharing of a device as an Assignable Device Interface (ADI). In response to a request for a virtual device composition, an ADI is selected based on affinity to the same NUMA node as the running virtual machine, utilization metrics for the Input-Output Memory Management Unit (IOMMU) unit and utilization metrics of a device of a same device class. Selecting the ADI based on locality and utilization metrics reduces latency and increases throughput for a virtual machine running critical or real-time workloads.

### BACKGROUND

Virtualization allows system software called a virtual machine monitor (VMM), also known as a hypervisor, to create multiple isolated execution environments called virtual machines (VMs) in which operating systems (OSs) and applications can run. Virtualization is extensively used in enterprise and cloud data centers as a mechanism to consolidate multiple workloads onto a single physical machine while still keeping the workloads isolated from each other.

With software-based Input/Output (I/O) virtualization, the VMM exposes a virtual device (such as network interface controller (NIC) functionality, for example) to a VM. A software device model in the VMM or host operating system (OS) emulates the behavior of the virtual device. The software device model translates virtual device commands to physical device commands before forwarding the commands to the physical device.

VMMs may make use of platform support for Direct Memory Access (DMA) and interrupt remapping capability (such as Intel® VT-d) to support ‘direct device assignment’ allowing guest software to directly access the assigned device. This direct device assignment provides the best I/O virtualization performance since the VMM is no longer in the way of most guest software accesses to the device. However, this approach requires the device to be exclusively assigned to a VM and does not support sharing of the device across multiple VMs.

Single Root I/O Virtualization (SR-IOV) is a PCI-SIG defined specification for hardware-assisted I/O virtualization that defines a standard way for partitioning endpoint devices for direct sharing across multiple VMs or containers. An SR-IOV capable endpoint device may support one or more Physical Functions (PFs), each of which may support multiple Virtual Functions (VFs). The PF functions as the resource management entity for the device and is managed by a PF driver in the host OS. Each VF can be assigned to a VM or container for direct access. SR-IOV is supported by multiple high performance I/O devices such as network and storage controller devices as well as programmable or reconfigurable devices such as Graphics processing Units (GPUs), Field Programmable Gate Arrays (FPGAs) and other emerging accelerators. In some embodiments, SR-IOV is implemented using PCIe. In other embodiments, interconnects other than PCIe may be used.

As hyper-scale computing models proliferate along with an increasing number of processing elements (for example, processing cores) on modern processors, a high-volume computing platform (for example, computer server) is used to host an order of magnitude higher number of bare-metal or machine containers than traditional VMs. Many of these usages such as network function virtualization (NFV) or heterogeneous computing with accelerators require high performance hardware-assisted I/O virtualization. These dynamically provisioned high-density usages (that is, on the order of 1,000 domains) demand more scalable and fine-grained I/O virtualization solutions than are provided by traditional virtualization usages supported by SR-IOV capable devices.

Scalable I/O virtualization (Scalable IOV) defines a scalable and flexible approach to hardware-assisted I/O virtualization targeting hyper-scale usages. Scalable IOV builds on an already existing set of Peripheral Component Interconnect (PCI) Express capabilities, enabling the Scalable IOV architecture to be easily supported by compliant PCI Express endpoint device designs and existing software ecosystems.

Scalable IOV enables highly scalable and high-performance sharing of I/O devices across isolated domains, while containing the cost and complexity for endpoint device hardware to support such scalable sharing. Depending on the usage model, the isolated domains may be traditional VMs, machine containers, bare-metal containers, or application processes.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an example of a high-level software architecture for Scalable IOV

FIG. 2 illustrates a logical view of Assignable Device Interface (ADIs) with varying numbers of device backend resources, and virtualization software composing virtual device (VDEV) instances with one or more ADIs

FIG. 3 is an example of a system that includes a plurality of nodes, a plurality of IOMMUs and a plurality of Scalable IOV devices;

FIG. 4 is an example of an ADI selection tree in a system supporting non-uniform memory (NUMA) that includes a plurality of Input/Output Memory Management Units (IOMMU) that span across multiple nodes;

FIG. 5 is a flowgraph of a method to select an ADI for a device class;

FIG. 6 is a flowgraph of a method to perform an intelligent selection of an ADI for a device class;

FIG. 7 is a sequence flow diagram to perform an intelligent selection of an ADI for a device class; and

FIG. 8 is a block diagram of an embodiment of a server 800 in a cloud computing system.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

Scalable IOV allows efficient and scalable sharing of I/O devices across a large number of containers or VMs. The I/O devices support a large number of command/completion interfaces for efficient multiplexing/demultiplexing of I/O. Scalable IOV assigns the I/O device interfaces to isolated domains at a fine granularity. Scalable IOV defines the granularity of sharing of a device as an Assignable Device Interface (ADI). Each ADI instance on the device encompasses the set of resources on the I/O device that are allocated by software to support direct-path operations for a virtual device.

A Virtual Device (VDEV) is an abstraction through which a shared physical device is exposed to a VM. Each VDEV is backed by one or more ADIs from a similar class of devices.

Orchestration software can statically configure fine grained device resources that can be assigned to a VM. This is typically performed using a VM configuration file. However, the static mapping needs to be modified if the VDEV composition needs to be changed. Thus, static mapping is not scalable across different nodes in a cluster.

An Operating System (OS) can track a free pool of ADIs for each device class. On a request for a VDEV composition, the first available ADI can be selected from the free pool. However, the best available ADI from the free pool may not be selected to compose the VDEV. This may result in higher latencies and poorer throughput for critical workloads running in the VM. For example, a high priority, latency sensitive process/VM can obtain a sub-optimal ADI assignment, resulting in Service Level Agreements (SLAs) being missed whereas a low priority (for example, garbage collection or statistics gathering) function can obtain an optimal ADI assignment.

The ADI selection mechanism does not have visibility into application requirements, application priorities, utilization metrics (for example for Input/Output Memory Management Units (IOMMU)). Furthermore, there is a lack of intelligence in decision making including capabilities to make intelligent decisions and/or implement pre-defined heuristics in ADI assignments.

Instead of selecting the first available ADI from a free ADI pool in response to a request for a VDEV composition, an ADI is selected based on locality and utilization metrics of different interacting components. The ADI is dynamically selected based on affinity to the same NUMA node as the running VM.

Selecting the ADI based on locality and utilization metrics reduces latency and increases throughput for a VM running critical or real-time workloads. The ADI is selected based on affinity to the same NUMA node as the running VM, utilization metrics for the IOMMU unit and utilization metrics of a device of same device class. System software can use an API to request intelligent selection of an ADI for a device class by traversing the ADI selection tree to select the ADI for the device class. The traverse of the ADI selection tree is performed in response to the request from an application through an application programming interface (API) call.

This allows the VDEV composition module to use the ADIs from devices having the lowest utilization metrics. This enables efficient allocation and usage of platform hardware resources and flexibility and scalability, by efficiently utilizing device resources. Critical/real-time workloads inside the VM, can run efficiently and have better performance.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

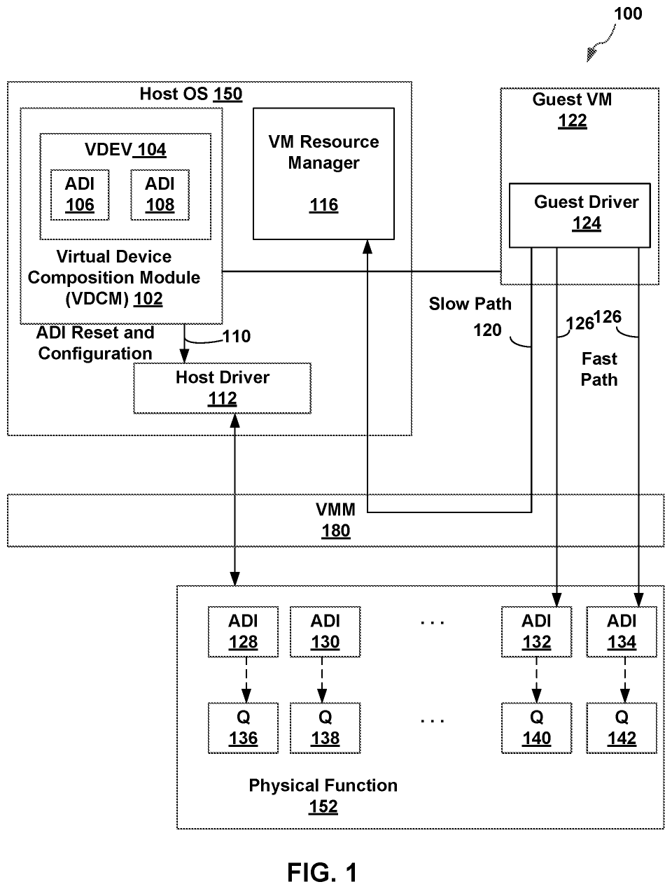

FIG. 1 is a block diagram of an example of a high-level software architecture for Scalable IOV 100. System software includes a host Operating System (OS) 150 and a VMM 180. The host OS 150 includes a Virtual Device Composition Module (VDCM) 102 that is responsible for composing one or more virtual device (VDEV) 104 instances utilizing one or more Assignable Device Interfaces (ADIs) 106, 108, by emulating VDEV slow path operations/accesses and mapping the VDEV fast path accesses to ADI instances allocated and configured on the physical device. VDCM 102 allows Scalable IOV devices to avoid implementing slow path operations in hardware and instead to focus device hardware to efficiently scale the ADIs 106, 108.

Additionally, virtualization management software (for example, VMM 180) uses VDCM 102 software interfaces for enhanced virtual device resource and state management, enabling capabilities such as suspend, resume, reset, and migration of virtual devices. Depending on the specific VMM implementation, VDCM 102 is instantiated as a separate user or kernel module or may be packaged as part of a host driver.

Host driver 112 is loaded and executed as part of host OS 150 or VMM (hypervisor) software 180. The VMM (hypervisor) software 180 can include and integrate OS components from host OS 150, such as a kernel. For example, VMware ESXi is a hypervisor that includes and integrates OS components, such as a kernel. In addition to the role of a normal device driver, host driver 112 implements software interfaces as defined by host OS 150 or VMM 180 infrastructure to support enumeration, configuration, instantiation, and management of a plurality of ADIs 128, 130, 132, 134. Host driver 112 is responsible for configuring each ADI 128, 130, 132, 134 such as its Process Address Space Identifier (PASID), device-specific Interrupt Message Storage (IMS) for storing ADI's interrupt messages, memory mapped I/O (MMIO) register resources for fast-path access to the ADI 128, 130, 132, 134, and any device-specific resources. Reset of an ADI 128, 130, 132, 134 is performed through software interfaces to host driver 112 via ADI reset configuration 110.

With software-based Input/Output (I/O) virtualization, the VMM exposes a virtual device (such as network interface controller (NIC) functionality, for example) to a VM. Some examples of a NIC are part of an Infrastructure Processing Unit (IPU) or data processing unit (DPU) or utilized by an IPU or DPU. An IPU or DPU can include a network interface, memory devices, and one or more programmable or fixed function processors (e.g., CPU or XPU) to perform offload of operations that could have been performed by a host CPU or XPU or remote CPU or XPU. In some examples, the IPU or DPU can perform virtual switch operations, manage storage transactions (e.g., compression, cryptography, virtualization), and manage operations performed on other IPUs, DPUs, servers, or devices.

Table 1 illustrates an example of a high-level set of operations that host driver 112 supports for managing ADIs 128, 130, 132, 134. These operations are invoked through software interfaces defined by specific system software (for example, host OS 150 or VMM 180) implementations.

TABLE 1
Host driver interfaces for Scalable IOV
Description

Scalable IOV capability reporting for the PF.
Enumeration of types and maximum number of ADIs/VDEVs.
Enumeration of resource requirements for each ADI type.
Enumeration and setting of deployment compatibility for ADIs.
Allocation, configuration, reset, drain, abort, release of ADI and its
constituent resources.
Setting and managing PASID identity of ADIs.
Managing device-specific Interrupt Message Storage (IMS) for ADIs.
Enabling guest to host communication channel (if supported).
Configuring device-specific Quality of Service (QoS) properties of ADIs.
Enumerating and managing migration compatibility of ADIs.
Suspending/saving state of ADIs, and restoring/resuming state of ADIs.

Virtual Device Composition Module (VDCM) 102 is a device specific component responsible for composing one or more virtual device (VDEV) 104 instances using one or more ADIs 106, 108 allocated by host driver 112. VDCM 102 implements software-based virtualization of VDEV 104 slow path operations and arranges for fast path operations to be submitted directly to the backing ADIs 128, 130, 132, 134. Host OS 150 or VMM 180 implementations supporting such hardware-assisted virtual device composition may require VDCM 102 to be implemented and packaged by device vendors in different ways. For example, in some OS or VMM implementations, VDCM 102 is packaged as user-space modules or libraries that are installed as part of the device's host driver 112. In other implementations, VDCM 102 is a kernel module. If implemented as a library, VDCM 102 may be statically or dynamically linked with the VMM-specific virtual machine resource manager (VMRM) responsible for creating and managing VM resources. If implemented in the host OS kernel, VDCM 102 can be part of host driver 112.

Guest driver 124, resident in guest VM 122, manages VDEV instances 104 composed by VDCM 102. Fast path accesses 126 by guest driver 124 are issued directly to ADIs 132, 134 behind VDEV 104, while slow path accesses 120 are intercepted and virtualized by VM resource manager (VMRM) 116 and VDCM 102. Guest driver 124 can be deployed as a separate driver or as a unified driver that supports both host OS 150 and guest VM 122 functionality.

Virtual Device (VDEV) 104 is the abstraction through which a shared physical device is exposed to software in guest VM 122. VDEVs 104 are exposed to guest VM 122 as virtual PCI Express enumerated devices, with virtual resources such as virtual Requester-ID, virtual configuration space registers, virtual memory Base Address Registers (BARs), virtual MSI-X table, etc. Each VDEV 104 may be backed by one or more ADIs 128, 130, 132, 134. The ADIs backing a VDEV 104 typically belong to the same Physical Function (PF) 152 but implementations are possible where they are allocated across multiple PFs (for example, to support device fault tolerance or load balancing). The physical function (PF) 152 can include hardware queues 136, 138, 140, 142.

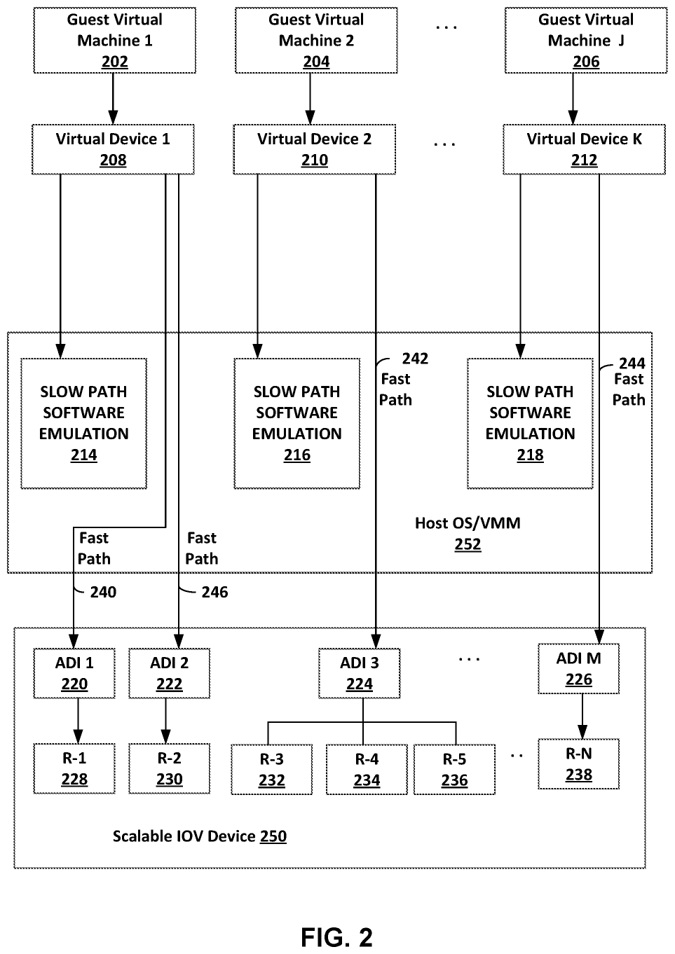

FIG. 2 illustrates a logical view of ADIs with varying numbers of device backend resources, and virtualization software composing virtual device (VDEV) instances 208, 210, 212 with one or more ADIs 220, 222, 224, 226. A virtual device (VDEV) can be composed from ADIs of a Scalable IOV device and assigned to a guest virtual machine (VM). A virtual machine can also be referred to as a partition.

There are one or more guest virtual machines (VMs) such as guest virtual machine 1 202, guest virtual machine 2 204, . . . guest virtual machine J 206, where J is a natural number, being executed by a computing platform. There are one or more virtual devices (VDEVs) such as virtual device 1 208, virtual device 2 210, . . . virtual device K 212, where K is a natural number, being executed by the computing platform. Each guest virtual machine 202, 204, 206 may call one or more virtual devices 208, 210, 212 for I/O requests. For example, guest virtual machine 202 calls virtual device 1 208, guest virtual machine 2 204 calls virtual device 2 210, and so on to guest virtual machine J calls virtual device K 212. There may be any number of guest virtual machines 202, 204, 206. There may be any number of virtual devices 208, 210, 212. The maximum number of virtual devices being called by any one guest virtual machine is implementation dependent. Within endpoint device hardware (that is, Scalable IOV device 250), there are one or more ADIs, such as ADI 1 220, ADI 2 222, ADI 3 224, . . . ADI M 226, where M is a natural number. There may be any number of ADIs in Scalable IOV device 250 (that is, it is implementation dependent), and there are one or more Scalable IOV devices (for example, network I/O devices) in the computing platform. The number of Scalable IOV devices 250 used in a computing platform is implementation dependent. Each ADI uses one or more device backend resources. For example, ADI 1 220 uses backend resource 1 (R-1) 228, ADI 2 222 uses backend resource 2 (R-2) 230, ADI 3 224 uses backend resource 3 (R-3) 232, backend resource 4 (R-4) 234, and backend resource 5 (R-5) 236, and ADI M 226 uses backend resource N (R-N) 238. The number of backend resources in Scalable IOV device 250 is implementation dependent.

A host operating system/VMM 252 performs slow path software emulation 214, 216, 218. Any virtual device 208, 210, 212 may take a slow path or a fast path for I/O requests for ADIs. For example, virtual device 1 208 can call slow path software emulation 214, fast path direct mapping 240 to ADI 1 220 or fast path direct mapping 246 to ADI 2 222 via fast path direct mapping 240. For example, virtual device 2 210 can call slow path software emulation 216 or fast path direct mapping 242 to ADI 3 224. For example, virtual device K 212 can call slow path software emulation 218 or fast path direct mapping 244 to ADI M 226.

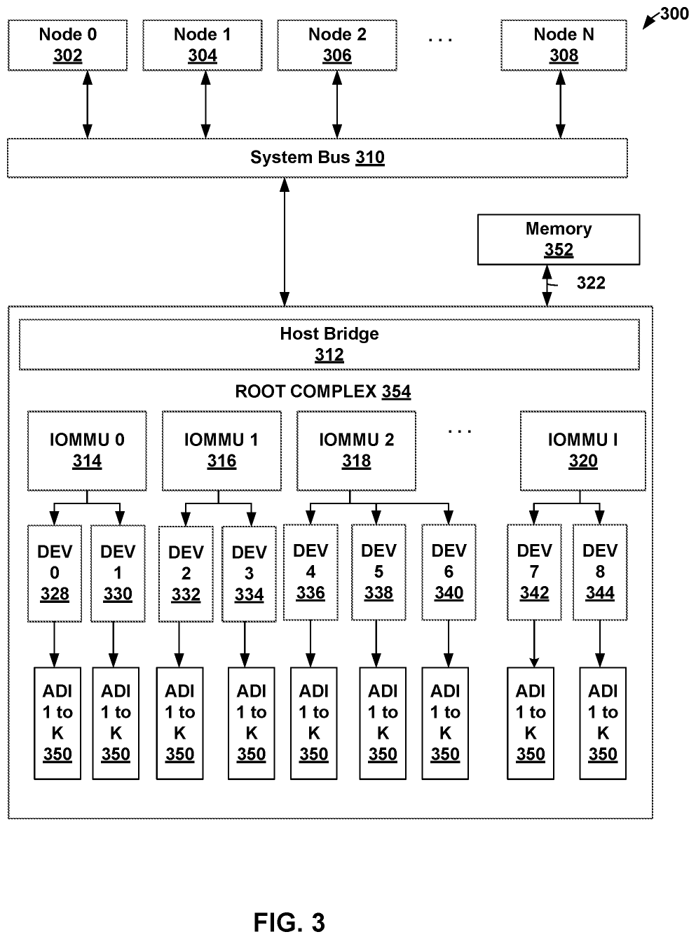

FIG. 3 is an example of a system 300 that includes a plurality of nodes 302, 304, 306, 308, a plurality of IOMMUs 314, 316, 318, 320 and a plurality of Scalable IOV devices 328, 330, 332, 334, 336, 338, 340, 342, 344.

A root complex 354 includes the plurality of IOMMUs 314, 316, 318, 320, the plurality of Scalable IOV devices 328, 330, 332, 334, 336, 338, 340, 342, 344 and a plurality of ADIs 350. The root complex 354 also includes a host bridge 312 communicatively coupled to a system bus 310 and a memory bus 322. The system bus 310 is also communicatively coupled with the plurality of nodes 302, 304, 306, 308. The memory bus 322 is communicatively coupled to a memory 352.

The plurality of nodes 302, 304, 306, 308 communicate via the system bus 310 with the root complex 354 using the PCIe (Peripheral Component Interconnect Express) protocol. The PCIe standards are available at www.pcisig.com.

Each of the plurality of nodes 302, 304, 306, 308 includes a processor and is associated with a NUMA node and a proximity domain (PD). NUMA is a computer memory architecture used in multiprocessing, where memory access time is dependent on the location of the memory relative to the processor. NUMA nodes are reported through an Advanced Configuration and Power Interface (ACPI) Static Resource Affinity Table (SRAT). ACPI is a standard for device configuration and power management by the operating system.

The ACPI SRAT stores topology information for the processors and memory that describes physical locations of the processors and memory in the system. The operating system scans the ACPI SRAT at boot time and uses the information stored in the ACPI STRAT to allocate memory. For example, the ACPI STRAT allows the operating system to associate processors, memory ranges and generic initiators (for example, heterogenous processors and accelerators, GPUs and I/O devices with integrated compute or DMA engines) with system locality/proximity domains and clock domains.

In the system shown in FIG. 3 the IOMMUs 314, 316, 318, 320 (labeled IOMMU 0-I) span across the nodes 302, 304, 306, 308 (labeled node 0-N). Each NUMA node provides the association between each IOMMU and the proximity domain (PD) to which the IOMMU belongs. Scalable IOV devices 328, 330, 332, 334, 336, 338, 340, 342, 344 (labeled dev 0-8) are assigned to respective IOMMUs 314, 316, 318, 320 (labeled IOMMU 0-I). Scalable IOV devices 328, 330, 332, 334, 336, 338, 340, 342, 344 (labeled dev 0-8) are associated with one or more Assignable Device interfaces (ADI) 350. A Remapping Hardware Static Affinity structure (RHSA) in the BIOS provides the association between each IOMMU 314, 316, 318, 320 and the proximity domain to which that IOMMU 314, 316, 318, 320 belongs.

The memory 352 can be a volatile memory. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (double data rate version 3, original release by JEDEC (Joint Electronic Device Engineering Council) on Jun. 27, 2007, currently on release 21), DDR4 (DDR version 4, JESD79-4 initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5, originally published by JEDEC in January 2020, HBM2 (HBM version 2), originally published by JEDEC in January 2020, or others or combinations of memory technologies, and technologies based on derivatives or extensions of such specifications. The JEDEC standards are available at www.jedec.org.

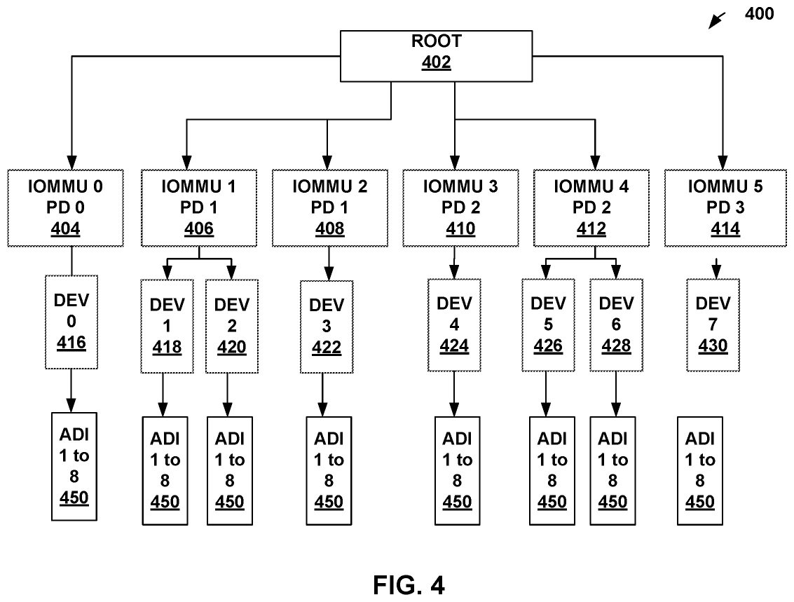

FIG. 4 is an example of an ADI selection tree 400 in a system supporting non-uniform memory (NUMA) that includes a plurality of Input/Output Memory Management Units (IOMMU) 404, 406, 408, 410, 412, 414 that span across multiple nodes. The ADI selection tree 400 includes root 402. System Basic Input/Output (BIOS) starts at root 402 and enumerates the association between each IOMMU unit 404, 406, 408, 410, 412, 414 and the proximity domain (PD) to which the IOMMU unit 404, 406, 408, 410, 412, 414 belongs. Each Scalable IOV device (Dev 0-7) implemented in the PCIe bus hierarchy is attached to an IOMMU unit 404, 406, 408, 410, 412, 414. A device driver (for example, host driver 112) enumerates the list of available ADIs 450 to system software during device registration. The ADI selection tree 400 allows intelligent selection of an ADI 450 for a VDEV 104 based on affinity to the same NUMA node as the running VM, utilization metrics for the IOMMU unit 404, 406, 408, 410, 412, 414 and utilization metrics of a Scalable IOV device 416, 418, 420, 422, 424, 426, 428, 430 of a same device class.

System software can use an Application Programming Interface (API) to request intelligent selection of an ADI 450 for a device class. The inputs to the ADI selection tree 400 include intelligent selection policy, VM NUMA home node and device class.

In the example shown in FIG. 4, there are six IOMMU units 404, 406, 408, 410, 412, 414, IOMMU 0 404, IOMMU 3 410 and IOMMU 5 414 each has one Scalable IOV device, IOMMU 1 404 and IOMMU 4 412 each have two Scalable IOV devices. Each Scalable IOV device has 1-8 ADIs 450.

During boot-up, the operation system (OS) kernel builds the ADI Selection Tree 400 using the ACPI SRAT and Intel® Virtualization Technology for Directed I/O (VT-d) tables (DMA-remapping hardware unit definition Structure (DRHD) and RHSA). A DMA-remapping hardware unit definition (DRHD) structure uniquely represents a remapping hardware unit present in the platform. The system BIOS is responsible for detecting remapping hardware functions in the platform and for locating memory-mapped remapping hardware registers in host system address space.

The ADI Selection Tree 400 maintains a hierarchical relationship between NUMA nodes, IOMMUs, Scalable IOV devices and ADIs. The ADI Selection Tree 400 also maintains utilization metrics for each remapping unit and devices in a sorted tree. These utilization metrics are updated by the OS kernel at regular intervals, typically seconds.

When a VM powers-on, the NUMA Home node affinity to which the VM's resources are allocated is determined. System software uses an intelligent selection policy to request ADIs 106, 108 from the Virtual Device Composition Module (VDCM) 102 (FIG. 1). The Virtual Device Composition Module (VDCM) 102 (FIG. 1) uses the ADI Selection Tree 400 to determine available ADIs for a specific class of device based on locality and utilization metrics.

In addition, in order to preserve priorities that may be determined at the application level by users, an optional user configuration file can be used to specify a priority High, Medium, Low) for a VM and an option to incorporate priorities in the selection policy, or override the selection policy with priorities. If there is a conflict in resource allocation, the priority assigned to each VM is used to determine the best ADI to assign. For example, if two VMs request a VDEV composition, based upon the VM's priority (High/Med/Low), the ADI is assigned to the VM with the higher priority.

Utilization metrics for the IOMMUs can be determined by periodically polling individual performance monitoring counters in the IOMMUs. Utilization metrics for the Scalable IOV devices can be determined by periodically calling an Application Program Interface (API) to the host driver 112. The inputs to the API are Selection Policy, VM Numa Home Node, and Device Class. The selection Policy can be intelligent, static, or dynamic. The output of the API is the ADI that is selected based on the input values.

The utilization metrics for the IOMMU and Scalable IOV devices are used to select an available ADI for a proximity domain in the ADI Selection Tree 400. In the ADI Selection tree 400 in FIG. 4, IOMMU 1 406 and IOMMU 2 408 belong to proximity domain PD1. The utilization metrics for IOMMU 1 406 and IOMMU 2 408 are read from monitoring counters in the IOMMUs. The IOMMU with the lowest utilization is selected. For example, if the utilization of IOMMU 1 406 is 35% and the utilization of IOMMU 2 408 is 65%, IOMMU 1 406, IOMMU 1 406, the IOMMU with the lowest utilization is selected.

IOMMU 1 406 has two Scalable IOV devices 418, 420. The Scalable IOV device with the lowest utilization is selected. For example, if the utilization of Scalable IOVs device 418 is 10% and the utilization of Scalable IOVs device 420 is 40%, scalable IOV device 418 with the lowest utilization is selected. At the ADI level, one of the available ADIs is selected.

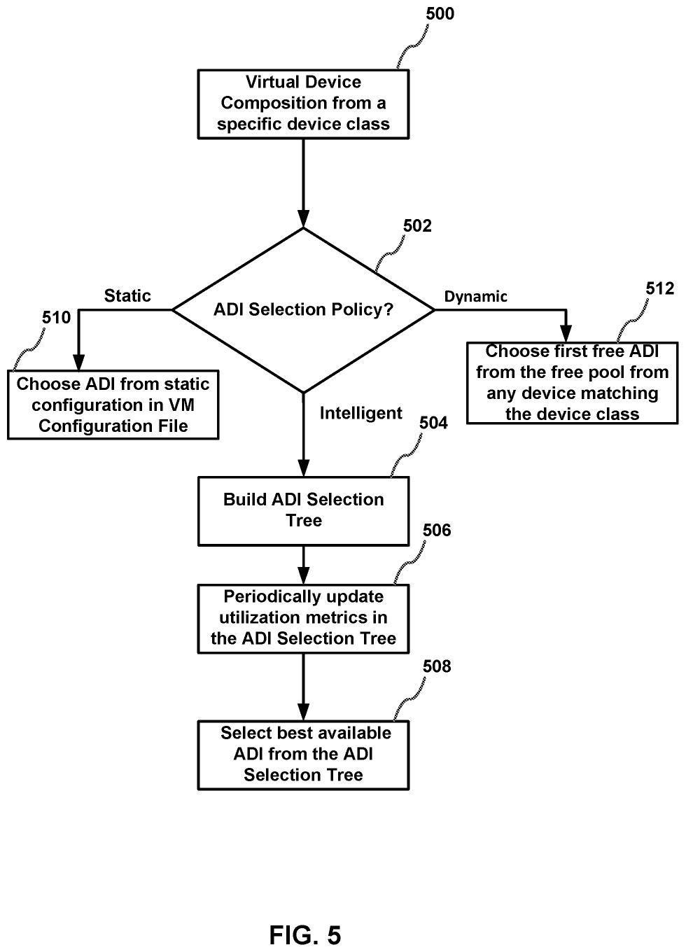

FIG. 5 is a flowgraph of a method to select an ADI for a device class.

At block 500, during power on of the VM, a new virtual device (VDEV) is composed from a list of available ADIs by querying the ADI Selection Tree.

At block 502, the ADI selection policy can be static, dynamic or intelligent. If the ADI selection policy is intelligent, processing continues with block 504. If the ADI selection policy is static, processing continues with block 510. If the ADI selection policy is dynamic, processing continues with block 512

At block 504, the ADI selection tree described in conjunction with FIG. 4 is generated. Processing continues with block 506.

At block 506, the operating system periodically updates utilization metrics in the ADI selection tree shown in FIG. 4 at periodic intervals (in seconds). The operating system periodically updates the utilization metrics based on a poll interval that can be user-defined or OS defined. For example, the poll interval can be between 5-30 seconds. In an embodiment, the default poll interval is 30 seconds.

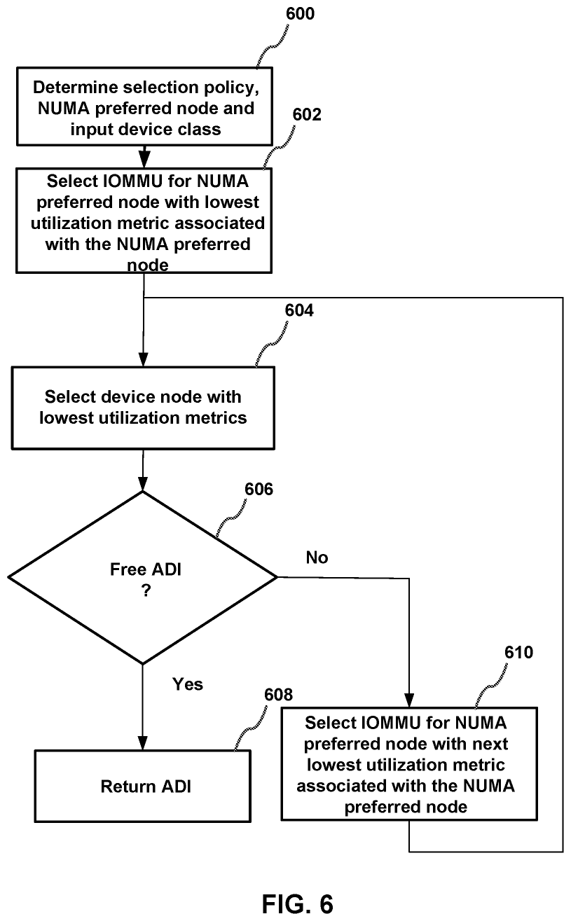

At block 508, an intelligent search is performed using the ADI selection tree in FIG. 4 to select the ADI for the device class. The intelligent search is described later in conjunction with FIG. 6.

At block 510, the ADI selection policy is static. The ADI is selected from the static configuration stored in a VM configuration file.

At block 512, the ADI selection policy is dynamic. The first free ADI is selected from the free pool from any device matching the device class.

FIG. 6 is a flowgraph of a method to perform an intelligent selection of an ADI for a device class.

At block 600, user priority inputs (high/medium/low) are read from the VM configuration file, the selection policy is intelligent and the NUMA preferred node of the running VM and input device class for which an ADI is to be selected are determined. Processing continues with block 602.

At block 602, based on the NUMA preferred node and Device Class, the operating system traverses the ADI Selection Tree 400. The operating system traverses to the IOMMU child node matching the NUMA preferred node. IOMMU child nodes are sorted in the order of increasing utilization metrics. If multiple IOMMU child nodes are present, the operating system selects the IOMMU child node with the lowest utilization metrics. Processing continues with block 604.

At block 604, after the IOMMU child node has been selected, the operating system walks to the Device child nodes for the selected IOMMU child node for the requested Device Class. Device child nodes are sorted in the order of increasing utilization metrics. If multiple Device child nodes are present, the operating system selects the device child node with the lowest utilization metrics. Processing continues with block 606.

At block 606, after the device child node has been selected. The device child node is queried for free ADIs. If there is a free ADI in the free pool of ADIs, processing continues with block 608. If not, processing continues with block 610.

At block 608, there is a free ADI in the free pool of ADIs, the ADI is returned

At block 610, an ADI is not available for the device for the IOMMU matching the NUMA preferred node, the next IOMMU (under non-NUMA preferred Node) with lowest utilization metric is selected. Processing continues with block 604.

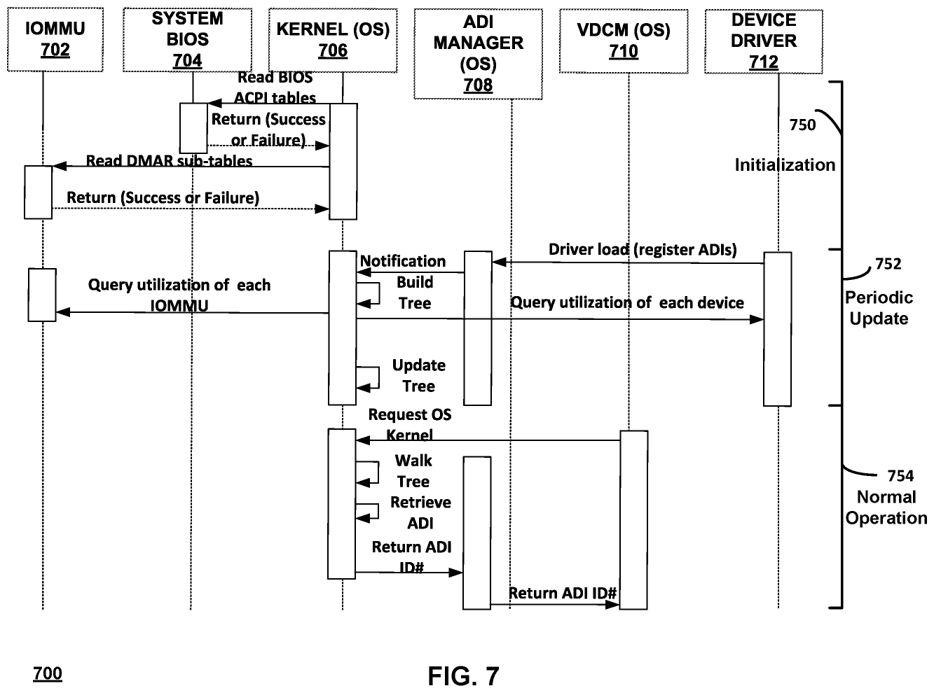

FIG. 7 is a sequence flow diagram 700 to perform an intelligent selection of an ADI for a device class.

During initialization 750, the kernel (OS) 706 reads the ACPI table in system BIOS 704 and reads DMA Remapping Reporting (DMAR) sub-tables in the IOMMU 702. The sub-tables that are read include Intel® Virtualization Technology for Directed I/O (VT-d) sub-tables (DRHD Structure (DMA Remapping Hardware Unit Definition Structure) and RHSA Structure (Remapping Hardware Static Affinity Structure)) and an ACPI Specification sub-table (SRAT (System Resource Affinity Table)).

During periodic update 752, the device driver 712 sends the device driver's list of ADI resources to the ADI manager 708 in the operating system. The ADI manager 708 stores the free list of ADIs. The kernel (OS) 706 updates the ADI Selection tree 400. The kernel (OS) 706 sends a utilization query to the IOMMU 702 to obtain the utilization of each IOMMU. The kernel (OS) 706 sends a query to the device driver 712 to obtain the utilization of each device. The kernel (OS) 706 performs an update of the ADI Selection Tree 400 based on the utilization of each IOMMU and each device.

During normal operation 754, in response to a request for an ADI received from the VDCM (OS) 710, the kernel (OS) 706 walks the ADI Selection Tree 400, retrieves the ADI and returns the ADI ID number to the VDCM (OS) 710.

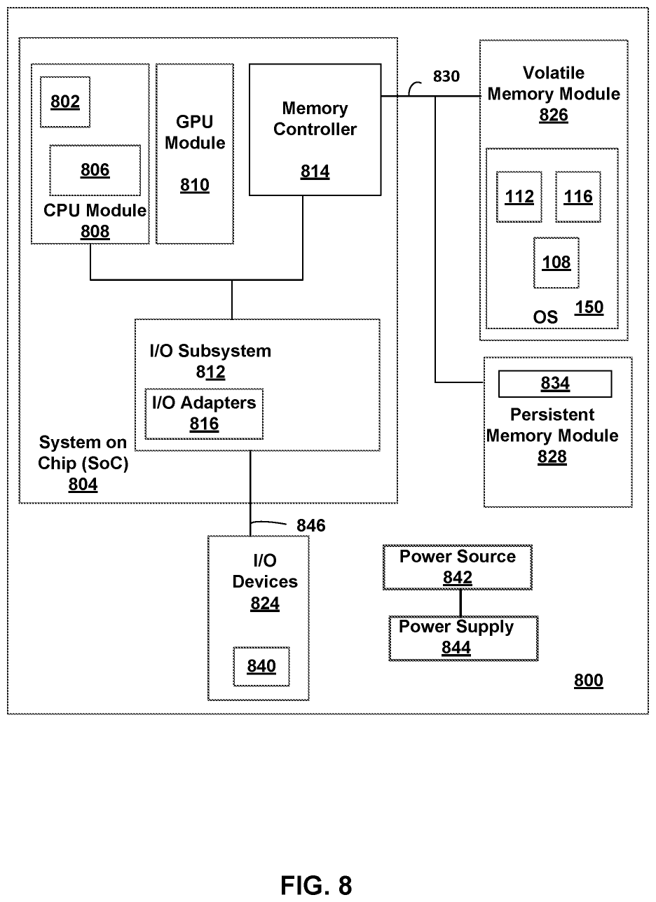

FIG. 8 is a block diagram of an embodiment of a server 800 in a cloud computing system. Server 800 includes a system on chip (SOC or SoC) 804 which combines processor, graphics, memory, and Input/Output (I/O) control logic into one SoC package.

The SoC 804 includes at least one Central Processing Unit (CPU) module 808, a memory controller 814, and a Graphics Processor Unit (GPU) module 810. In other embodiments, the memory controller 814 may be external to the SoC 804 and the GPU module may be external to the SoC 804. The CPU module 808 includes at least one processor core 802 and a level 2 (L2) cache 806.

Although not shown, the processor core 802 may internally include one or more instruction/data caches (L1 cache), execution units, prefetch buffers, instruction queues, branch address calculation units, instruction decoders, floating point units, retirement units, etc. The CPU module 808 may correspond to a single core or a multi-core general purpose processor, such as those provided by Intel® Corporation, according to one embodiment. In an embodiment the SoC 804 may be an Intel® Xeon® Scalable Processor (SP) or an Intel® Xeon® data center (D) SoC.

The memory controller 814 may be coupled to a persistent memory module 828 and a volatile memory module 826 via a memory bus 830. The persistent memory module 828 may include one or more persistent memory device(s) 834. The persistent memory module 828 can be a dual-in-line memory module (DIMM) or a small outline dual in-line memory module (SO-DIMM).

The host operating system 150 including the VDCM 102, VM Resource manager 116 and the host driver 112 is stored in the volatile memory module 826. The host operating system 150 can be Microsoft® Windows® (Network Driver Interface System (NDIS) or NetAdapter drivers), Linux®, VMware® ESXi, Microsoft® Hyper-V, Linux® Kernel-based Virtual Machine (KVM), or Xen Project® Hypervisor.

The persistent memory module 828 includes persistent memory device(s) 834. A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also include a byte-addressable write-in-place three dimensional crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

The Graphics Processor Unit (GPU) module 810 may include one or more GPU cores and a GPU cache which may store graphics related data for the GPU core. The GPU core may internally include one or more execution units and one or more instruction and data caches. Additionally, the Graphics Processor Unit (GPU) module 810 may contain other graphics logic units that are not shown in FIG. 8, such as one or more vertex processing units, rasterization units, media processing units, and codecs.

Within the I/O subsystem 812, one or more I/O adapter(s) 816 are present to translate a host communication protocol utilized within the processor core(s) 802 to a protocol compatible with particular I/O devices. Some of the protocols that I/O adapter(s) 816 may be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 816 may communicate over bus 846 with external I/O devices 824 which may include, for example, user interface device(s) including a display and/or a touch-screen display 840, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices may be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)). The I/O adapter(s) 816 may include a Peripheral Component Interconnect Express (PCIe) adapter.

Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

Power source 842 provides power to the components of server 800. More specifically, power source 842 typically interfaces to one or multiple power supplies 844 in server 800 to provide power to the components of server 800. In one example, power supply 844 includes an AC to DC (alternating current to direct current) adapter to plug into a wall outlet. Such AC power can be renewable energy (e.g., solar power) power source 842. In one example, power source 842 includes a DC power source, such as an external AC to DC converter. In one example, power source 842 or power supply 844 includes wireless charging hardware to charge via proximity to a charging field. In one example, power source 842 can include an internal battery or fuel cell source.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A non-transitory machine-readable storage medium can cause a machine to perform the functions or operations described, and includes any mechanism that stores information in a form accessible by a machine (for example, computing device, electronic system, etc.), such as recordable/non-recordable media (for example, read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. One or more non-transitory machine-readable storage medium comprising a plurality of instructions stored thereon that, in response to being executed, cause a system to:
store, a selection tree, the selection tree including a plurality of Input/Output Memory Management Units (IOMMU) for a preferred node and a device for each IOMMU; and
traverse the selection tree to select an Assignable Device Interface (ADI) for a virtual device (VDEV) based on affinity to a same node as a running Virtual Machine (VM), first utilization metrics for the IOMMUs and second utilization metrics of a device of a same device class.

2. The one or more non-transitory machine-readable storage medium of claim 1, wherein the traverse of the selection tree is performed in response to a request from an application through an application programming interface (API) call.

3. The one or more non-transitory machine-readable storage medium of claim 1, wherein the plurality of instructions, when executed, further cause the system to periodically update the first utilization metrics and the second utilization metrics in the selection tree.

4. The one or more non-transitory machine-readable storage medium of claim 1, wherein the plurality of instructions, when executed, further cause the system to select an IOMMU with a lowest first utilization metrics.

5. The one or more non-transitory machine-readable storage medium of claim 4, wherein the plurality of instructions, when executed, further cause the system to select the device with a lowest second utilization metrics.

6. The one or more non-transitory machine-readable storage medium of claim 4, wherein the device is Scalable I/O virtualization.

7. The one or more non-transitory machine-readable storage medium of claim 4, further cause the system to select a first free ADI.

8. The one or more non-transitory machine-readable storage medium of claim 1, wherein the preferred node is a NUMA preferred node and the same node is a NUMA same node.

9. A method comprising:
storing a selection tree including a plurality of Input/Output Memory Management Units (IOMMU) for a preferred node and a device for each IOMMU; and
traversing the selection tree to select an Assignable Device Interface (ADI) for a virtual device (VDEV) based on affinity to a same node as a running Virtual Machine (VM), first utilization metrics for the IOMMUs and second utilization metrics of a device of a same device class.

10. The method of claim 9, wherein the traversing of the selection tree is performed in response to a request from an application through an application programming interface (API) call.

11. The method of claim 9, further comprising:
periodically updating the first utilization metrics and the second utilization metrics in the selection tree.

12. The method of claim 9, further comprising:
selecting an IOMMU with a lowest first utilization metrics.

13. The method of claim 12, further comprising:
selecting the device with a lowest second utilization metrics.

14. The method of claim 12, wherein the device is Scalable I/O virtualization.

15. The method of claim 12, further comprising:
selecting a first free ADI.

16. The method of claim 12, wherein the preferred node is a NUMA preferred node and the same node is a NUMA same node.

17. A system comprising:
a central processing unit having a plurality of cores and a memory controller; and
a memory coupled to the memory controller;
wherein the system is configured to:
store, in the memory, a selection tree, the selection tree including a plurality of Input/Output Memory Management Units (IOMMU) for a preferred node and a device for each IOMMU; and
traverse the selection tree to select an Assignable Device Interface (ADI) for a virtual device (VDEV) based on affinity to a same node as a running Virtual Machine (VM), first utilization metrics for the IOMMUs and second utilization metrics of a device of a same device class.

18. The system of claim 17, wherein the traverse of the selection tree is performed in response to a request from an application through an application programming interface (API) call.

19. The system of claim 17, wherein the system to periodically update the first utilization metrics and the second utilization metrics in the selection tree.

20. The system of claim 17, wherein the system to select an IOMMU with a lowest first utilization metrics.

21. The system of claim 20, wherein the system to select the device with a lowest second utilization metrics.

22. The system of claim 20, wherein the device is Scalable I/O virtualization.

23. The system of claim 20, wherein the preferred node is a NUMA preferred node and the same node is a NUMA same node.
